(19) United States
(12) Patent Application Publication
(10) Pub. No.: US 2008/0149406 A1
(43) Pub. Date: Jun. 26, 2008

(54) Remote mover

(76) Inventor: Ida Antoinette Williams, Philadelphia, PA (US)

Correspondence Address: Ida Williams, Apt. B, 141 S. 57th St., Philadelphia, PA, 19131, US

(21) Appl. No.: 11/643,989

(22) Filed: Dec. 22, 2006

(51) Int. Cl. B60K 1/00

(52) U.S. Cl. 180/65.1

(57) ABSTRACT

A remote controlled self-propelled cart allows a physically compromised user desired movement of equipments and appliances by visual orientation without physical effort. The cart has a self-contained power supply with wheels driven by motors allowing small appliances to be moved over a horizontal surface such as the floor of a room for user accessibility and to storage after use.

### CROSS-REFERENCE TO RELATED APPLICATION

Not applicable.

### STATEMENT REGARDING FEDERALLY SPONSORED RESEARCH OR DEVELOPMENT

Not Applicable

### REFERENCE TO MICROFICHE APPENDIX

Not Applicable

### BACKGROUND OF THE INVENTION

This invention relates to a remote controlled appliance cart providing relatively compact, highly versatile, low cost control mechanisms for moving and positioning light-weight appliances thereby providing a lightweight, compact, highly versatile robotic appliance moving and orientation system.

A substantial amount of work has been done in providing appliance moving equipment over the years. An example of a typical appliance moving equipment is disclosed in U.S. Pat. No. 6,634,658 B2 to Larouche and, also, in U.S. Pat. No. 7,132,955 B2 to Choi et. al. These patents are m particularly illustrative of problems faced by the prior in providing convenient small appliance movement for persons of limited physical strength or those confined to beds or otherwise physically handicapped.

### SUMMARY OF THE INVENTION

It is a principal object of the present invention to provide an improved appliance cart, one that is versatile with respect to human energy requirements required for moving a relatively heavy appliances on a two-dimensional surface for desired positioning.

Another object of the invention is to provide a novel, base-mounted remotely activated control system for such an appliance cart.

A further object of the invention is to provide a remotely controlled cart which can perform moving operations on two-dimensional surfaces such as on a carpeted floor allowing convenient moving and storage of appliances, for example, a television set or small refrigerator, without physical exertion or by inconveniently having to move to the appliance, thereby allowing optimized positioning and convenient movement to storage thereafter.

Another object of the invention is to provide convenient movement of carted appliances by persons of limited physical means.

Another object of the invention is to provide a moveable cart remotely activated which can smoothly be positioned without the use of cumbersome cables or wires.

Another object of the invention is to utilize remote power control of the driving wheels of a cart containing appliances, by use of a common transmitter activating received signals controlling a powered cart.

A further object of the invention is to provide visually oriented positioning of a cart containing appliances by means of button movement on a remote control transmitter thereby coordinating horizontal movement of the cart using motor-activated wheels operating in X and Y coordinate directions or by any desired combinations thereof.

A further object is to provide coordinated movement of carted appliance on a horizontal plane achieving smooth movement with minimized application of human energy.

Another object of the invention is to provide improved means for coordinated movement of carted appliances on a horizontal plane by generation and transmission of signals in the digital time domain without the use of cables or wires.

Other objects of the invention will be obvious to those skilled in the art on their reading of this description.

The above objects have been substantially accomplished by the construction of a remotely moveable cart apparatus of the type comprising self-contained motors controllably activating wheels in both the X- and Y-coordinate directions or by combination of these coordinates by rotation in a plane coplanar with such horizontal direction allowing visually controlled cart movements by motor means moving said wheels corresponding to operator-positioned joystick or push-buttons mounted on the transmitter. A receiver mounted on the cart activates wheels powered by rechargeable batteries.

The motor means for moving said moveable cart on a horizontal plane is controllably activated using transmission by IR LED emission of selected wavelength or by means of radio frequency transmission using binary digital signaling.

The electrical motor means and wheels provide motive power for moving the cart. It is anticipated that substantial force can be applied to the wheels of the cart by merely providing larger motors and batteries in the base of the wheeled cart without change of the signal transmitter or receiver. The provision of independently powered motors, using microprocessor controlled activation, allows a common controller for a large number of power sources thereby providing for a variety of different-sized moveable carts.

It should also be understood that the apparatus described herein may be substantially modified, e.g., with respect to the movement because of separation of the radio signal controlled controller from the motor power driving source. For example, were one to wish to provide power to the wheels for a large cart no change of the remote controller apparatus is necessary. Moreover, if one preferred to utilize a preferred motor control system one could select a battery/potentiometer combination allowing optimized power consumption or it would be entirely practical to operate and control the apparatus with stepping motors for example.

It may be desirable to have different motor systems to maintain desirable gearing ratios. It is preferred that direct current, servo-motors geared down to the desired operating speed, usually from about 2 to 20 inches per second, be used to drive the wheels.

In order to provide smooth movement of the cart it is desirable to coordinate the relative speed of the motor movement and this is easily achieved by visual observation of the cart “horizontal movement” desired by combination of visual sighting and signaling. The position-activation joystick of the control box is used to send a signal to the respective drive motor circuit board driving the respective wheel, or wheels. Since no positioning indication sensors are required it is therefore not necessary to anticipate by a “difference signal” and simple visual sighting is all that is necessary for cart positioning. What is achieved by controlling the horizontal positioning motors with reference to visual sighting is horizontal movement driven at precisely determined values. When the X-coordinate horizontal movement motor-driven wheels are controlled by, i.e., servoed to, the Y-coordinate horizontal movement motor-driven wheels, the desired result is achieved without any need to feed a precise independent input to the respective horizontal coordinate motors to have them respond with the proper relationship for a combined vector movement.

### Remote Control Signaling

There are two major types of wireless remote controls. The type commonly used for televisions uses infrared transmission, while garage doors, car alarms and model airplanes use radio. Some of the older types used ultrasonic sound.

Infrared remote controls use infrared light which is just below the red portion of the visible spectrum, and so is invisible to the human eye. Infrared remote controls work in much the same way as radio remotes, except that instead of transmitting the signal over radio waves the signal is transmitted using pulses of infrared light. Since they use light they cannot penetrate walls or work around corners very well. This can be an advantage as well as a disadvantage. Imagine if your kids kept changing the channel on your TV from their room!

Infrared remote controls work well but they do have some limitations related to the nature of infrared light. First, infrared remotes have a range of only about 30 feet (10 meters), and they require line-of-sight. This means the infrared signal won't transmit through walls or around corners—a straight line to the device you're trying to control is required.

Infrared light is so ubiquitous that interference can be a problem with IR remotes. A few everyday infrared-light sources include sunlight, fluorescent bulbs and the human body. To avoid interference caused by other sources of infrared light, the infrared receiver on a TV only responds to a particular wavelength of Infrared light, usually 980 nanometers. There are filters on the receiver that block out light at other wavelengths. Still, sunlight can confuse the receiver because it contains infrared light at the 980-nm wavelength. To address this issue, the light from an IR remote control is typically modulated to a frequency not present in sunlight, and the receiver only responds to 980-nm light modulated to that frequency. This system cuts down a great deal on interference.

While infrared remotes are the dominant technology in home theater applications, there are other niche-specific remotes that work on radio waves instead of light waves. A garage-door opener, for instance, uses an RF remote.

The greatest advantage to radio-frequency remotes is their range: They can transmit up to 100 feet from the receiver (the range for Bluetooth is shorter), and radio signals can go through walls. This benefit is why some IR/RF remotes are used for home-theater components. These remotes use RF-to-IR converters to extend the range of an infrared remote.

Instead of sending out light signals, Radio Frequency (RF) remote controls transmit radio waves that correspond to the binary command for the button being pushed. A radio receiver on the controlled device receives the signal and decodes it.

Radio frequency remote controls use a simple tuned transmitter and receiver to send the signal via radio. The typical frequency is around 400 MHz, but can vary widely, depending upon the unit involved. These frequencies are covered under Part 15 of the FCC rules, which authorize low power unlicensed radio systems.

RF remote controls are very common. Garage-door openers, car alarm fobs and radio-controlled toys have always used radio remotes, and the technology is starting to show up in other applications, too. Some Bluetooth-based remotes control laptops and smartphones.

The problem with RIF remotes is the sheer number of radio signals in the air at any given time, Cell phones, walkie-talkies, WiFi setups and cordless phones are all transmitting radio signals at varying frequencies. RIF remotes address the interference issue by transmitting at specific radio frequencies and by embedding digital address codes in the radio signal. This lets the radio receiver on the intended device know when to respond to the signal and when to ignore it.

A special digital coding system is used to separate one system from the next. For example, garage door openers use a series of small switches inside which you can use to set the “code.” This code is actually a binary number that differentiates your garage door system from your neighbors. This avoids both of your doors operating at the same time if both of your systems are on the same frequency.

To accomplish this a digital circuit in the transmitter creates a serial pattern of ones and zeros which are sent by the transmitter repeatedly to the receiver at the far end. The receiver recovers the pattern of ones and zeros, which are then sent to a decoder circuit. When the decoder circuit gets a pattern that matches what has been set by the user (the little switches set at each end) it provides a control signal to whatever gadget is to be controlled, be it a motor to open the garage door, or a switch to turn off the alarm in your car.

In order to keep the various remotes from interfering with each other, a special set of codes has been worked out that identify the make and model of television or stereo (or whatever) that is being controlled. This keeps your TV remote from starting up the VCR. Universal remotes work by allowing multiple different codes to be sent so that one device can control all of your components. Some remotes even “learn” by recording the pattern from all of your different, existing remotes, and then using the recorded pattern to control each different device.

Remote controls used for model automobiles or model airplanes are of the more sophisticated type that can be used for the cart moving apparatus. Instead of simply turning something on or off they can be used to control remotely a range of movement, such as wheel rotational speed on wheel orientation, on the remote controlled cart. In addition, these remote devices can perform many control tasks at once.

In operation these remote controls, convert information from the position of the control levers (or joysticks) to a series of digital pulses. The system may be as simple as changing the timing of the pulses, or as complex as actually sending the numerical value of the angle of the control via a binary number. Information from all of the channels is then combined into one continuous stream of data, which is then transmitted to the remotely controlled receiver located on the device via radio.

At the remote end, a receiver picks up the signal and recovers the original data stream. The data stream is fed into special decoding circuitry that separates the various channels and then recovers the position information which is sent on to the motors that do the actual mechanical controlling of the model.

7-bit binary commands, for example, are used by Sony for remote control code signals including the following binary codes commands: Power-on (001 0101), Power-off (010 1111), Volume up (001 0010), Volume down (001 0011), Channel up (001 0000), Channel down (001 0001), etc.

The remote signal includes more than the command for “volume up,” though. It carries several chunks of information to the receiving device, including: a “start” command, the command code for “volume up”, the device address (so the TV knows the data is intended for it), a “stop” command (triggered when the “volume up” button is released), etc. So when the “volume up” button on a Sony TV remote is pressed it sends out a series of pulses using a space-coding method in which the length of the spaces between pulses of light represent a one or a zero.

When the infrared receiver or the RF receiver on the TV picks up the signal from the remote and verifies from the address code that it's supposed to carry out this command, it converts the light or radio pulses back into the electrical signal, for example the binary command 001 0010. It then passes this signal to the microprocessor, which goes about implementing the command. The “stop” command tells the microprocessor it can stop increasing the volume, for example.

The described binary signal controlled circuit is one way in which the horizontal-motor-driving circuit can be utilized to control the activity of the movement of the cart in a horizontal plane by either IR or radio frequency signal activation means, however numerous other such signal-control means can also be employed.

It has been found particularly advantageous to utilize RF radio-controlled circuitry controlling geared-down direct current motors. Cable or wire driven powered electrical supply is thereby avoided eliminating resonance or vibration-imparting problems (which are associated with the use of such cables and stepping motors).

The placement of receiver, circuit boards, batteries, and motors on the cart reduces bulk and puts the weight near the center of gravity of the cart contributing to stability. The receiving controller, associated battery supplies, potentiometers and other apparatus contained within the cart are positioned taking into account the centers of gravity and are a substantial benefit in stabilizing the robot cart apparatus.

Typical travel specifications of the apparatus comprise travel limited to the range of the IR remote, about 30 feet for IR and 100 feet for RF. Since IR cannot be used through walls because it is light-operated it may advantageously be used within a room disallowing IR interference outside the room. RF transmission, which allows signal transmission though walls provides signal transmission about 100 feet. For hospital operations, this could be particularly advantageous because the cart could be moved in a programmed pattern allowing, for example, RF signal control overriding signals by a patient if it was necessary for supervisory personnel to control positioning of a mobile cart, operation of the appliances within it, or movement to storage

It is important to note that there is nothing in the design to preclude the cart traveling over a much larger range if the remote signal allows activation. The cart can advantageously be adapted to turn 360 angular degrees if required. Controlled turning and positioning allows the enclosed equipment to be moved wherever desired.

Changing the “joystick” position on the remote control sets in motion a series of events causing the controlled device to carry out commands. For movement of the cart the process works as follows: By remote control, information from the position of the operator-controlled control levers (or joystick) is converted to a series of digital pulses. The system may be as simple as changing the timing of the digital pulses or as complex as actually sending the numerical value of the digitized angle of the control via binary numbers.

When the joystick is pushed forward it causes circuitry to contact and complete the “move forward” circuit on the microprocessor integrated circuit in the transmitter (not shown). The integrated circuit then sends the binary “move forward” command to the infrared LED or radio frequency transmitter using binary coded pulses from the front of the remote or the antenna respectively. The IR LED sends out a series of light pulses or the RF transmitter sends out a series of radio frequency pulses corresponding to the joystick or lever positioning command code. Information from all of the channels is then combined into one continuous stream of data which is then transmitted to the remotely controlled device via IR or RF.

At the remote end, a receiver picks up the signal and recovers the original data stream. This data stream is fed into special decoding circuitry that separates the various channels and recovers the position information which is sent on to the motor control boards then to the motors that do the actual mechanical controlling of the wheels.

When the receiver on the cart picks up the signal from the remote it verifies from the address code that it's supposed to carry out this command and converts the IR or RF pulses back into the electrical signal, for example 001 0010. It then passes this signal to the microprocessor which is part of the receiver circuitry and goes about controlling the wheel speed or direction. The “stop” command tells the microprocessor it can stop increasing the wheel speed or direction.

Mounted for movement on the cart are wheels which consequently may be directed and turned at desired speed and direction by signals from the remote control.

### ILLUSTRATIVE EMBODIMENT OF THE INVENTION

In the application and accompanying drawings there is shown and described a preferred embodiment of the invention suggesting various alternatives and modifications thereof, but it is to be understood that these are not intended to be exhaustive and that other changes and modifications can be made within the scope of the invention. These suggestions herein are selected and included for purposes of illustration in order that others skilled in the art will more fully understand the invention and the principles thereof and will be able to modify it and embody it in a variety of forms, each as may be best suited for the conditions of a particular need.

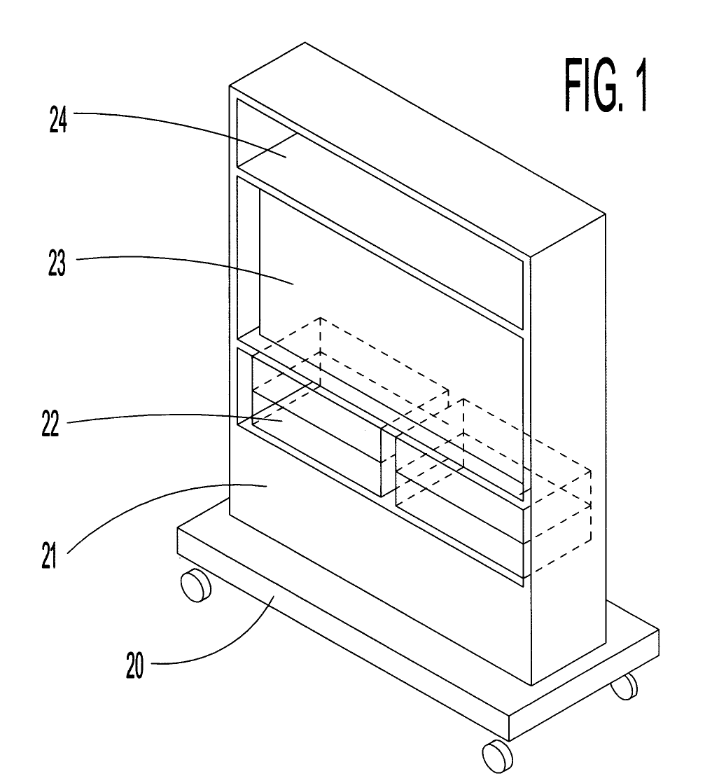

FIG. 1 is perspective view of a remotely controlled powered cart allowing positioning of enclosed equipments or appliances, constructed according to the invention.

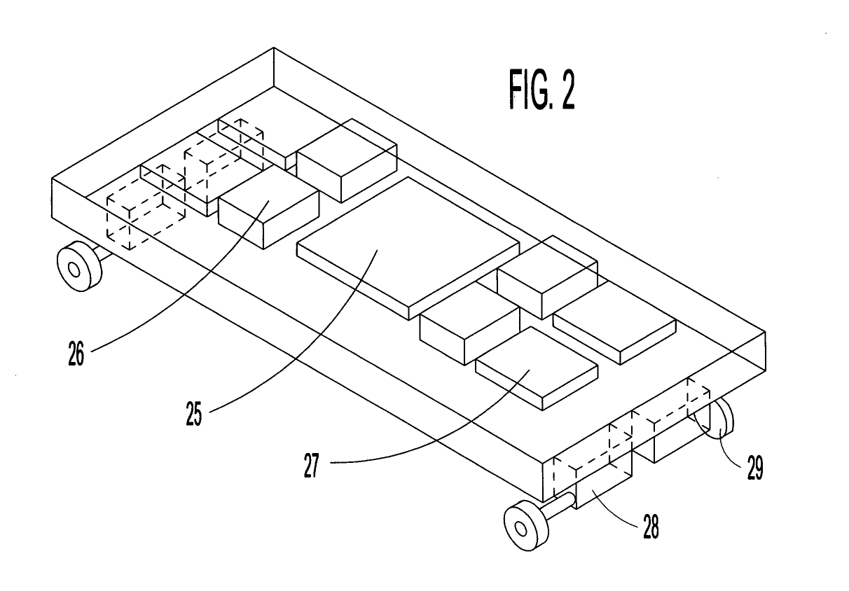

FIG. 2 is a schematic elevation of the apparatus of the invention indicating the relative position of the motors, batteries, and principal signal receiving member within the powered cart.

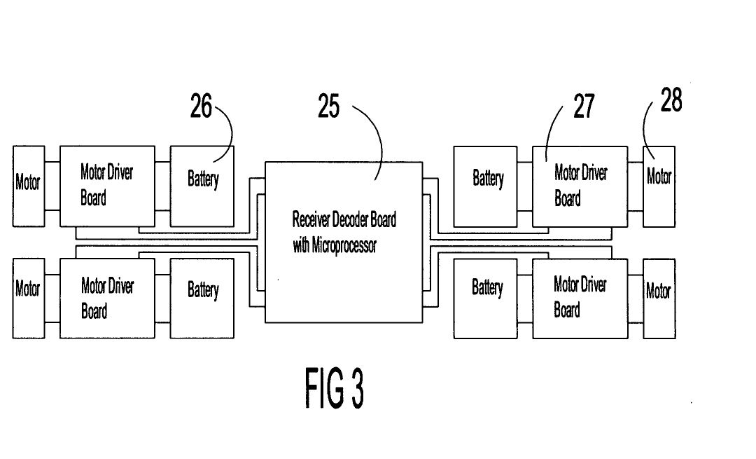

FIG. 3 is schematic diagram indicating a preferred way of generating pulses from a remote of either IR or RF type for operation of the motors driving the wheels on the cart.

FIG. 1 shows remote control cart 20 carrying appliance/equipment holder 21 containing desired equipments 22 and appliances such as TV 23 for moving. Miscellaneous items of smaller nature may be stored in compartment 24. To avoid tipping during movement appliance/equipment holder 21 is attached to control cart 20 by means of tape, straps, or Velcro® strips. This attachment means allows different-sized, different-designed appliance/equipment holders 21 to be attached to a common control cart 20. Equipments 22 or appliances 23 carried in the equipment/appliance holder 21 may be similarly attached to avoid dropping.

FIG. 2 illustrates details of the receiver controller circuitry in the moveable powered cart, with lid removed. A signal-sensing receiver 25, containing a microprocessor, is digitally controlled by IR or RF electrical signals transmitted by the remote transmitter (not shown). Receiver 25 controls Motor Drive Board 27 which in turn controls Wheel Motor 28. Electrical power is supplied to the Motor Control board 27 from Battery 26.

FIG. 3 shows the schematic drawing illustrating a preferred way of generating pulses from a remote of either the IR or RF type (not shown), for operation of the motors driving the wheels on the cart. A digital circuit in remote transmitter (not shown) creates a serial pattern of ones and zeros sent to receiver 25 in the moveable powered cart. Receiver 25 recovers the pattern of ones and zeros, which are then sent to motor drive circuit 27. Motor decoder circuit 27 matches the pattern set by the user (using select switches set at both transmitter and receiver) provide a control signal which operates wheel motors 28. Electrical power is supplied by batteries 26.

Motion of the robotic cart is thereby desirably accomplished by the motor-driven wheels wherein by combination of motors and the motor control system provide individual parts that may be cooperatively used to achieve desired controlled movement of the cart.

By the inventive combination an improved appliance moving cart, one that is saving of human energy normally required for moving a relatively heavy appliances on a two-dimensional surface allows desired positioning to be accomplished. The base-mounted remotely activated equipment and appliance holder can be remotely controlled to perform moving operations on two-dimensional surfaces such as on a carpeted floor allowing convenient moving and storage of appliances, for example, a television set, without physical exertion or inconveniently having to move to the appliance thereby allowing optimized viewing and convenient movement to storage thereafter.

The inventive combination provides a remotely moveable cart achieving smooth positioning without the use of cumbersome cables or wires. By use of a common receiver activated by transmitted signals from the remote control, power control of the driving wheels of the cart is isolated thereby accommodating various-sized equipment and appliance holding containers. The apparatus is particularly applicable to transporting appliances and equipments when moving from one location to another. Another advantage of the invention is for providing convenient movement of carted appliances by persons of limited physical means. These and other desired uses will be recognized by those skilled and knowledgeable in the state of the art.

It is to be understood that the following claims are intended to cover all of the generic and specific features of the invention herein described and all statements of the scope of the invention which might be said to fall therebetween.

What is claimed is:

1. A remotely controlled moveable cart apparatus comprising means to hold equipment and appliances allowing movement in the horizontal plane by 2-axis coordinate direction co-planar with said horizontal direction and by rotation of said cart by electrical operation of wheels on said cart by improvement comprising;
a. motor driven wheels mounted on said cart with self-contained electrical power means allowing rotation of said wheels as desired visually by operator, including
b. RF or IR remote control means for activating said motors, wherein
c. said remote control is by transmission of IR or RF digital signaling by accord with joystick positioning commands transmitted to receiver on said cart, whereby
d. motors operated by electrical simulation of said transmission commands cooperatively energize said wheels, thereby
allowing self-contained power for controlled cart movement of equipments and appliances without the requirement of direct human effort allowing physically incapacitated operators easy movement control of equipments and appliances.

2. A remote controlled apparatus as defined in claim 1 wherein said motor means are direct current servo motors and wherein movement is in horizontal plane along X- and Y-direction or combination thereof as synchronously-controlled by sensing positioning of joystick or button means.

3. The remotely-controlled cart moving means of claim 1 wherein the signal sensing means comprises a transmitter operating by binary digital signaling to receiver mounted on said cart controllably operating wheels affixed to said cart as powered by self-contained batteries, said electrical signals by coordinated action operating a servo-motor operating system and thereby achieving smooth operation movement of said wheels for positioning control of said cart in synchronism with operator controlled movement of said joystick.

4. A defined in claim 1 said cart is adapted to move in a horizontal direction in response to signals to motors slaved to move in combined X- and Y-direction by correspondence with joystick positioning of remote signal transmission as visually directed by operator.

5. A remotely operated cart as defined in claim 1 wherein the motor control system of said operating systems allows wheel operating speed and direction to be determined, at least in part, by separate motor control systems.
